(19) United States
(12) Patent Application Publication
(10) Pub. No.: US 2003/0135604 A1
(43) Pub. Date: Jul. 17, 2003

(54) INTEGRATED UNITS WITH DIAGNOSTIC CAPABILITIES

(76) Inventors: ROBERT G. HARRISON, SEATTLE, WA (US); ROBERT D. LAMSON, SEATTLE, WA (US)

Correspondence Address: SONNENSCHEIN NATH & ROSENTHAL, P.O. BOX 061080, WACKER DRIVE STATION - SEARS TOWER, CHICAGO, IL, 60606-1080, US

(21) Appl. No.: 09/116,785

(22) Filed: Jul. 16, 1998

(51) Int. Cl. H04N 7/16; H04H 9/00; H04B 17/00; G06F 15/173

(52) U.S. Cl. 709/224; 455/67.1; 725/9

(57) ABSTRACT

Systems which have an integrated unit that allows both television signals and information retrieved from an onboard information storage device or the Internet to be presented in visual, audio, or visual/audio form via output devices such as television screens and audio speakers. The operating mode—television, Internet, or stored information retrieval and display—is selected by the user. The system also has a diagnostic mode in which information on the status of an appliance associated with the system is made available to a repair or service facility at a site removed from the location of the integrated unit and the application. Status information may also be displayed on a CRT or other visual display component of the integrated unit.

### CROSS REFERENCE TO A RELATED APPLICATION

The present application is copending with and is entitled to the benefit of the filing date of provisional application No. 60/006,166 filed July 1997 and also entitled INTEGRATED UNITS WITH DIAGNOSTIC CAPABILITES.

### TECHNICAL FIELD OF THE INVENTION

The present invention relates to novel integrated units which combine: (1) the functions of a television or other entertainment device; (2) an observe-then-perform educational and instructional CD mode of operation; and (3) a major appliance controller with diagnostic capabilities.

In one currently important application, units embodying the principles of the present invention are configured for use in a home kitchen. In the interests of brevity and clarity, the principles of the invention will be developed primarily with reference to that exemplary application of the invention. It is to be understood, however, that this is being done for the reasons stated above and is not intended to limit the scope of the invention.

### BACKGROUND OF THE INVENTION

Heretofore proposed have been information retrieval and display systems which include an integrated module having: (a) a player for an optically readable, encoded data storage device such as a video compact disc, an audio compact disc, a laser disc, or a digital video disc; (b) a player for retrieving data from the disc; and (c) a screen on which the retrieved information can be displayed. Stored on the optically readable disc are data constituting instructions or other information sought by the user. In a kitchen setting this information may include, for example, video demonstrations of the steps involved in preparing a selected dish, recipe ingredient lists, and video demonstrations or information on the use and operation of utensils and appliances employed in preparing a selected item. In general, a host of information on cooking and other food preparation techniques, advice on stocking a pantry, and other kitchen-related subjects can be made available as well as information specific to a particular recipe including demonstrations of steps employed in preparing the item, ingredient lists, cooking times and temperatures, times for the accomplishing of other steps such as the marinating of meats, etc.

In these novel heretofore proposed units, provision is made for interfacing the unit with a major appliance so that the integrated unit can receive feedback from the appliance and can make displays showing the status of the appliance available to the user on the screen of the integrated unit.

### SUMMARY OF THE INVENTION

Disclosed herein are new and novel multimode units which have the features and capabilities identified above and, in addition, have the ability to make information on the status of the appliance available to a user and to a repairman or other person at a site removed from the location of the multimode unit and the appliance.

The ability to make diagnostic information available at a repair facility or other remote location is an important advantage of the units disclosed herein. This can eliminate the expense and bother of repeated service calls. The information available to the service facility may allow the repairman to bring all of the needed parts with him on the first service call if the appliance breaks down, as the repairman may already have the diagnostic information which identifies the particular problem with the appliance. As another example, the information available to the remote facility may warn the personnel at that facility of an impending problem, providing an opportunity to perform preventive maintenance and thereby avoid a breakdown or other destructive incident. The information available at the remote location also reminds service personnel to schedule routine maintenance on the appliance, which is important in maximizing the service life of the appliance.

The novel multimode units described herein have the ability to supervise more than one appliance and also have the capability of controlling the operation of the appliance as well as monitoring and reporting on the status of the appliance. A wide variety of appliances may be monitored with a unit of the character disclosed herein. These include, without limitation: kitchen stoves, refrigerators, freezers, central and window air conditioners, central heating systems, room heaters, and central vacuuming systems.

Units having components which allow the user to both watch television and retrieve information from an encoded data storage device in different, user-selected modes of operation can readily be provided. Such units retain the appliance monitoring and status reporting functions described above.

Furthermore, the novel integrated units disclosed herein may optionally be provided with other features of import including: (1) the capability of providing entertainment and information by way of audiovisual or audio discs, as well as via televised programs; (2) a modem which allows the user to log onto and navigate the Internet and; (3) mode controls which allow the user to switch between (a) television viewing or other entertainment, (b) if the option is provided, Internet access and navigation; (c) information retrieval from an encoded disc and presentation of that information in visual or audiovisual form; and (d) appliance supervising and controlling; and (4) the ability to extend the range of subjects on which information is available simply by replacing the active disk with a different one.

Another basic and important advantage of the present invention is that a number of currently discrete and typically physically separated functions—entertainment, perform-while-observing instruction/education, Internet access and navigation, and appliance supervision and control—are centralized at a single location and integrated in one unit.

The important objects, advantages, and features of the present invention will be apparent to the reader from the foregoing and as the ensuing detailed description and discussion of the invention proceeds in conjunction with the accompanying drawings.

### BRIEF DESCRIPTION OF THE DRAWINGS

FIG. 1 is a pictorial view of a multimode system which has appliance monitoring and status reporting capabilities; this system is constructed in accord with and embodies the principles of the present invention;

FIG. 2 depicts, in block diagram form, the operating system of an integrated multimode unit which is a component of the FIG. 1 system;

FIG. 3 is a block diagram showing the connections between an appliance (kitchen range) being monitored and the integrated unit of FIG. 2;

FIG. 4 is a block diagram showing control and data transfer components of the FIG. 3 range;

FIG. 5 is a view showing a remote control of the FIG. 1 system in more detail;

FIG. 6 depicts a display which appears on the screen of the integrated unit of the FIG. 1 system when the system user takes advantage of the system's appliance control capabilities to control the operation of a kitchen range;

FIGS. 7 and 8 are fragments of the display shown in FIG. 6 to an enlarged scale; these figures show one of four like touch-screen controls as they appear when an associated burner of the kitchen range is turned off (FIG. 7) and turned on (FIG. 8) to adjust the level of heat available from the burner;

FIG. 9 is a logic flow diagram visually depicting the operation of the FIG. 1 system;

FIG. 10 shows representative appliance status messages that may appear on the display screen of the FIG. 1 integrated unit;

FIG. 11 is a diagram showing how the operation of the FIG. 1 system in a user selected mode is frozen when the system is switched to operation in a different mode; this allows the system to pick up where it left off when operation is returned to the switched from mode; and

FIG. 12 depicts visually a data collection and storage arrangement employed in monitoring a refrigerator or appliance of similar character.

### DETAILED DESCRIPTION OF THE INVENTION

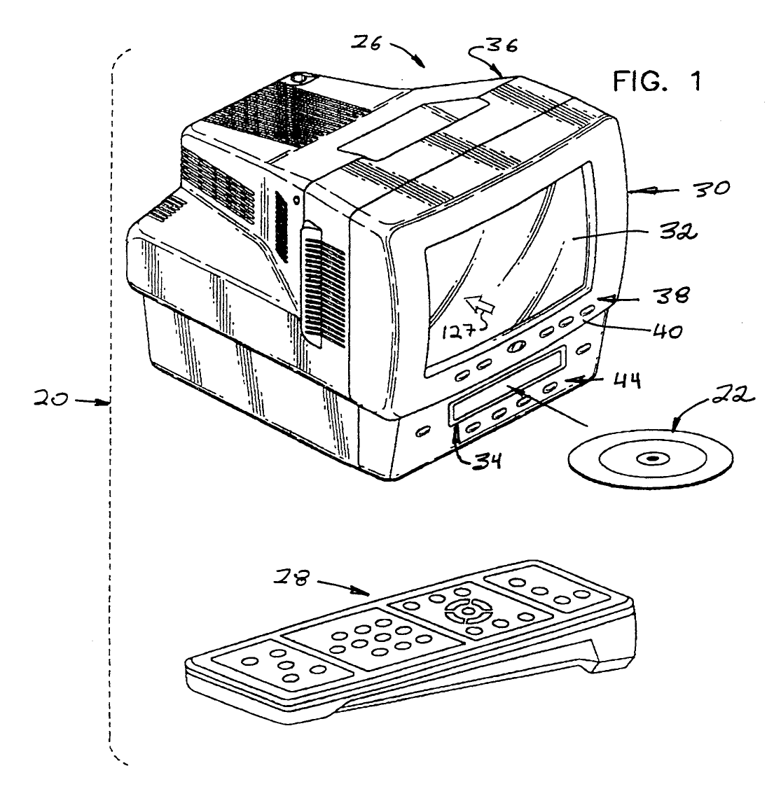

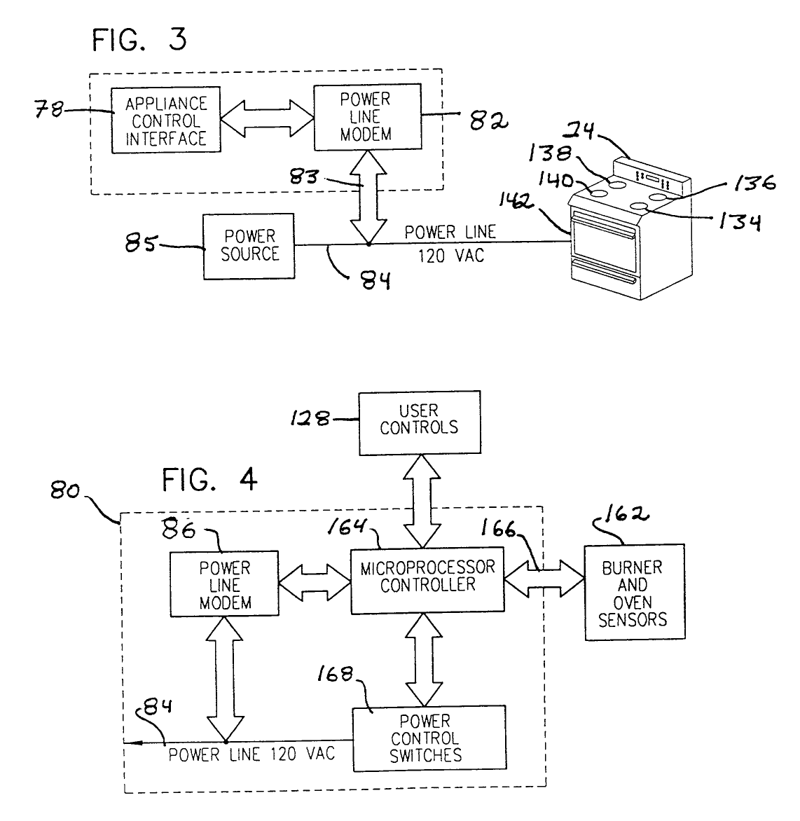

Referring now to the drawing, FIG. 1 depicts a system 20 so constructed that one can easily, and at any time, switch between: (a) watching television or playing an audio or visual compact disc or other optically readable disc in an ENTERTAINMENT mode of operation; (b) a CD mode of operation in which information stored on a Video 1.1, Video 2.0, DVD, or CDI disc 22 is retrieved and presented in a visual or visual/audio format; and (c) an INTERNET mode in which a system user can log onto and navigate the Internet. System 20 also has the capabilities of monitoring an appliance such the illustrated kitchen range 24 (see FIG. 3) and of displaying and transmitting to a service or repair facility information useful in servicing the supervised appliance.

The major components of system 20 are an integrated unit (or module) 26, a remote control 28, and the above-mentioned laser readable disc 22.

Integrated unit 26 includes a television set 30 which has a CRT (cathode ray tube) 31 with a screen 32 and a video compact disc player 34, both housed in the same cabinet 36. Conventional onboard controls 38 for television set 30 are located on the front panel 40 and the right-hand side panel 42 of cabinet 36, and onboard controls 44 for disc player 34 are also located on front cabinet panel 40. A conventional tray 46 is used to load disc 22 into player 34.

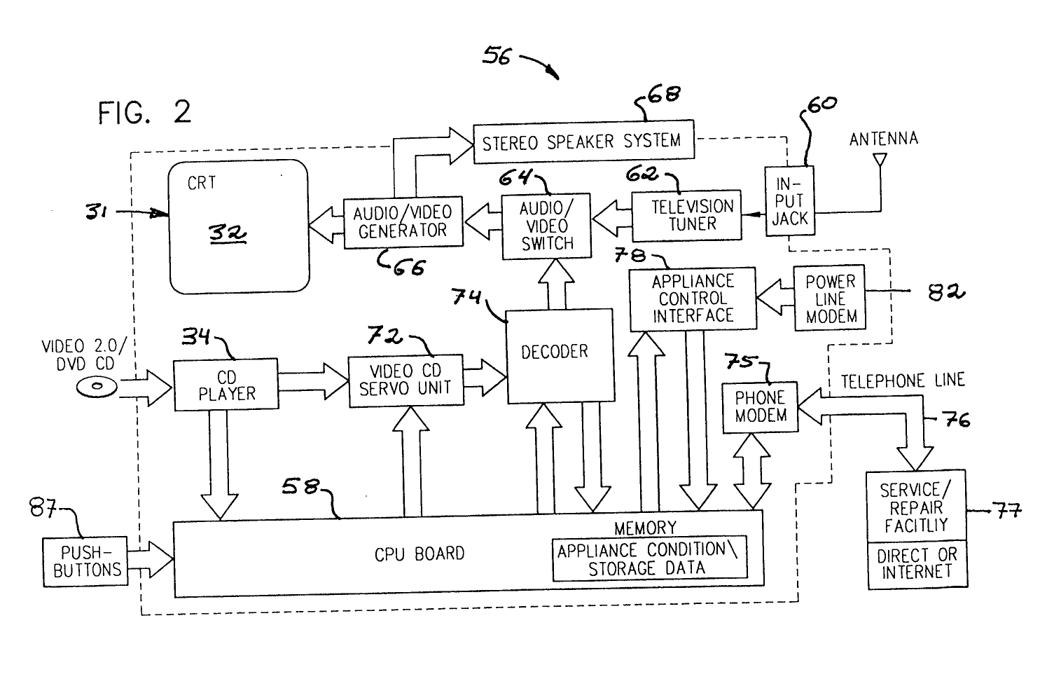

The internal operating components of integrated unit 26, depicted schematically in FIG. 2, constitute an integrated operating system identified by reference character 56. These components include a CPU board 58 and input jacks which are collectively identified by reference character 60 and which are employed to connect integrated unit 24 to a television signal source—a television antenna or cable and/or a VCR. A tuner 62 is employed by the user to select one of the available television channels to watch or the VCR channel (usually 3 or 4) at the user's location. The off-the-air or VCR signal is directed through an audio/video switch 64 to an audio/video generator 66. That system component converts the incoming signal to a video signal, which can be transformed into visual images by CRT 31. The visual images are displayed on the CRT screen 32 of television set 30. The incoming signal typically also includes an audio component which is converted to audible sound by audio/video generator 66 and the illustrated stereo speaker system 68.

In the CD mode of operation of system 20, data representing visual components of information are read from encoded disc 22, decoded, and displayed on CRT screen 32 of integrated unit 26. Audio components of the information read from disc 22 are converted to audible sound by stereo speaker system 68.

Disc player 34 has a conventional mechanism (not shown) for spinning optically readable disc 22 and an equally conventional laser pickup (likewise not shown) for reading information stored in digital data files in the tracks on disk 22. A video CD servo unit 72 controls the retrieval of information from disc 22.

A decoder 74 decodes the data retrieved from the disc. The decoded data is routed to audio/video generator 66 and there converted to signals which appear as dynamic or static visual images on CRT display screen 32 and to audio signals which stereo speaker system 68 converts to audible sound.

The operating system 56 of integrated unit 26 also includes a phone modem 75. The user of system 20 can log onto the Internet through this modem over telephone line 76 when integrated unit 24 is operating in the INTERNET mode. Also, modem 75 is employed to automatically connect system 20 to a service/ repair facility 77 over telephone line 76 if a problem is detected with an appliance supervised by the system or, as a further example, if it is time to schedule routine or other preventive maintenance.

Also included in system 56 is an appliance control, supervision, and feedback interface 78. As shown in FIGS. 3 and 4, this operating system component is linked to the control box 80 of the appliance(s) being controlled by system 20—in this case kitchen range 24—by modem 82 of operating system 56, bus 83, power line 84 connecting range 24 to a conventional A.C. power source 85, and a power line modem 86 in appliance control box 80.

The operation of system 20 is controlled by a CPU (not specifically shown) on CPU board 58. Among other things, CPU board 58 receives commands and information from and controls CD player 34, phone modem 75, and at least selected functions of the appliances linked to appliance control and supervision interface 78 by a power line 84. Also, CPU board 58 sets audio/video switch 64 to connect audio/video generator 66 to television tuner 62 if the ENTERTAINMENT mode of operation of system 20 is selected by a user. If the CD or INTERNET mode of operation is instead selected, CPU board 58 sets audio/video switch 64 to transmit signals received from video CD servo unit 72 or phone modem 75 to decoder 74 with the incoming data being decoded as necessary and then routed to audio/video generator 66.

Another important function of CPU board 58, operating in conjunction with appliance control and feedback interface 78, is to analyze the data flowing to the board from the appliance connected to integrated unit operating system 56. If a problem is detected, CPU board 58 causes appropriate warnings to be displayed on the CRT screen 32 of integrated unit 26. System 56 is also preferably programmed such that one can dial modem 75 from service/repair facility 77 and retrieve at that location the messages displayed on screen 32 of television set 30.

ENTERTAINMENT, CD, and INTERNET modes of operation are selected by the user with push buttons among those collectively identified in FIG. 2 by reference character 86. The foregoing and other push buttons employed to control the operation of system 20 are incorporated in remote control 28 and may also be duplicated on the front panel 40 of integrated unit cabinet 36.

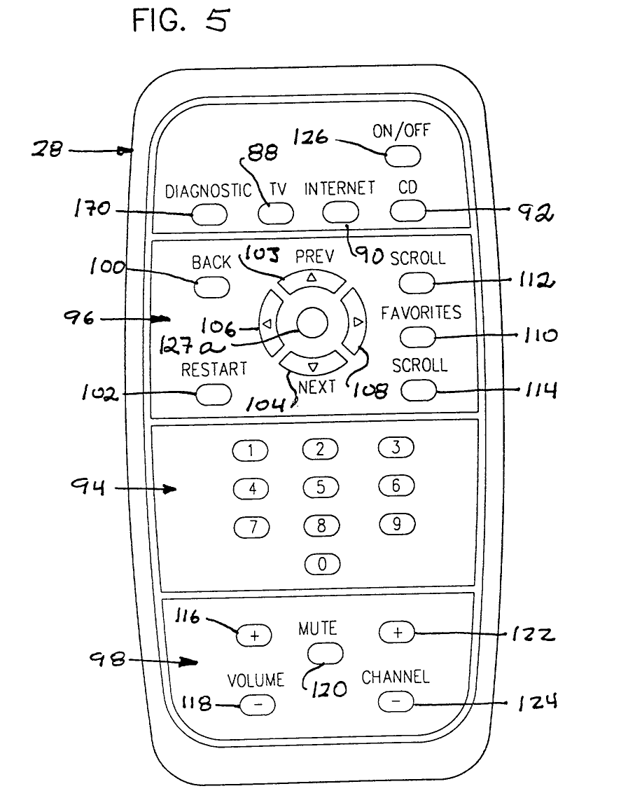

Turning now to FIG. 5, the remote control push buttons employed to select the ENTERTAINMENT, INTERNET, and CD modes of operation are respectively identified by reference characters 88, 90, and 92. Remote control 28 also has a numerical keypad 94 with push buttons \mathring{1}-\mathring{9} and two groups of push buttons respectively identified by reference characters 96 and 98. Push button group 96 includes BACK, RESTART, PREV, (previous), and NEXT buttons 100, 102, 103, and 104 employed by the system user in the COACH mode of operation with buttons 103 and 104 also being used in the INTERNET mode of operation, in that case as UP and DOWN arrow buttons. Also employed in the INTERNET operating mode are LEFT and RIGHT arrow buttons 106 and 108, favorites BUTTON 110, and UP and DOWN scroll buttons respectively identified by reference characters 112 and 114.

Push button group 98 includes push button controls utilized in the ENTERTAINMENT operating mode of system 20. These include volume UP and DOWN buttons 116 and 118, a MUTE switch 120, and CHANNEL selection push buttons 122 and 124, all having conventional functions.

Remote control 28 also has an ON/OFF push button 126. That switch turns off CRT 31 and stereo speaker system 68 off, but leaves operating system 56 powered up. This allows the system user to receive E-mail and other information over the Internet. Perhaps even more importantly in the context of the present invention, keeping operating system 56 of integrated unit 24 continuously powered up allows the system to exercise constant supervision over the appliance or appliances connected to integrated unit 24, eliminating the possibility that a problem or need to schedule maintenance might be undetected because of the monitoring system being turned off. It is also be noted that the appliance monitoring or supervising functions of system 20 stay in effect irrespective of whether the system is being operated in the ENTERTAINMENT, CD, or INTERNET mode.

User-actuated controls as incorporated in remote control 44 and optionally provided on board integrated unit 42 are employed in the ENTERTAINMENT, CD, and INTERNET modes of operation as follows:

ENTERTAINMENT—push buttons 116 and 118 raise and lower the volume of the sound propagated by speaker system 68. Mute switch 120 turns the sound off and then on if it is pressed a second time. Buttons 122 and 124 are employed to select the television channel to watch. The disk player 34 may also be used in the ENTERTAINMENT mode. The conventional onboard controls 44 of integrated unit 26 are used in this mode to operate the disk player; and in addition, remote control buttons 116 and 118 and mute button 120 may be used to control the level of sound and turn the sound off and on.

CD—numerical keypad buttons \mathring{1}-\mathring{9} and BACK, RESTART, NEXT, and PREV (previous) buttons 100, 102, 104, and 103 are employed by system user to interactively navigate through a hierarchy of menus to retrieve information of interest from optically readable disk 22 and to view an introductory video stored in digital form on disk 22. Hierarchical menus and how they are navigated with the above-discussed user-activatable controls are subjects discussed in detail in U.S. patent application Ser. No. 08/621,638 filed Mar., 25, 1996 and titled INFORMATION AND ENTERTAINMENT CENTER (now U.S. Pat. No. 5,724,102 which is hereby incorporated by reference into this specification).

INTERNET—remote control buttons 103, 104, 106, and 108 are employed to move a cursor 127 (see FIG. 2) around the screen 32 of integrated unit 26.

Pressing GO button 127a activates the instruction, command, etc. to which cursor 127 is pointing. Typically, this will be a hypertext link for jumping from one worldwide web site to another.

BACK button 100 has the opposite function. Pressing that button returns the system user to the site, etc. jumped from by pressing GO button 127.

Pressing FAVORITES buttons 110 brings up on integrated unit screen 32 a list of web sites stored in memory on CPU board 58. Cursor 127 is moved to the wanted site on this list with appropriate ones of the push buttons 103, 104, 106, and 108. GO button 127a is then pressed to connect system 20 to the selected web site.

Appliances do not have to be connected to the integrated unit 24 of system 20 by hard wiring as described above. Data can instead be transferred between integrated unit 26 and an appliance such as kitchen range 24 over existing telephone lines. This is a contemporary technology which employs a high frequency that does not interfere with the normal use of a telephone coupled to the same lines. Infrared, R-F (radio frequency), and possibly other communication systems may also be employed.

The specific construction of remote control 26 and the details of integrated unit 24 are not part of the present invention and accordingly do not appear in this specification or the accompanying drawings. To the extent that such information is of interest to the reader, it may be found in above-cited U.S. patent application Ser. No. 08/621638.

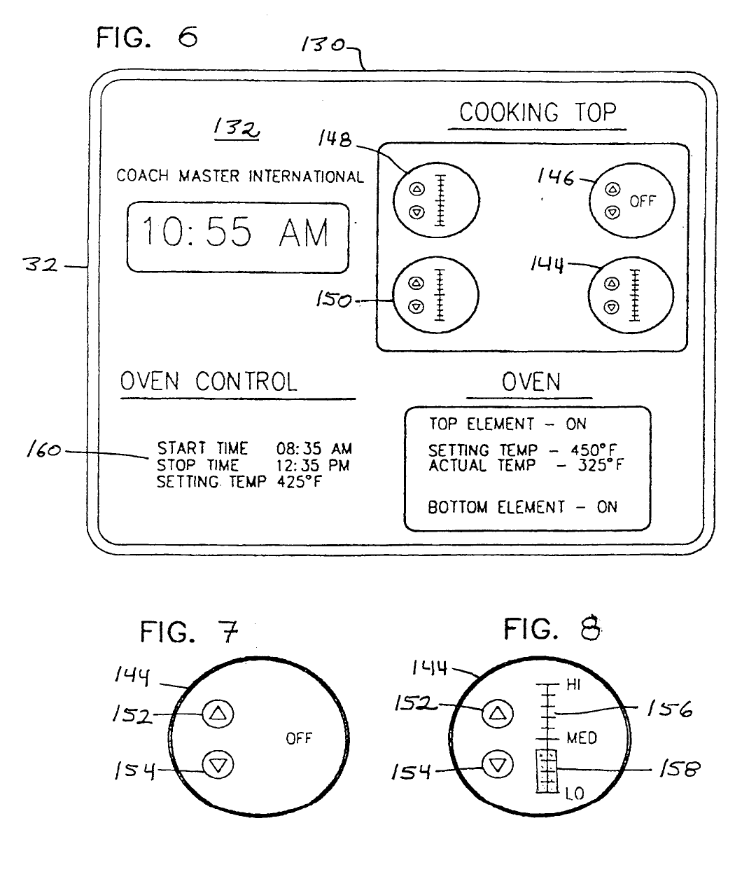

System 20 is designed to control at least selected functions of an appliance connected to integrated unit 26 as by power line 84 and power line modem 82. The controls exercised over kitchen range burners and oven are typical, and can be appreciated from the following discussion taken in conjunction with FIGS. 6-8 of the drawing and from FIG. 4 in which the controls available to the appliance user are collectively identified by reference character 128.

In the kitchen range control schemata of FIGS. 6-8, a touch screen 130 overlies the CRT screen 32 of integrated unit 24. FIG. 4 shows a display 132 which a user of system 20 can bring up on the CRT screen 32 of integrated unit 26.

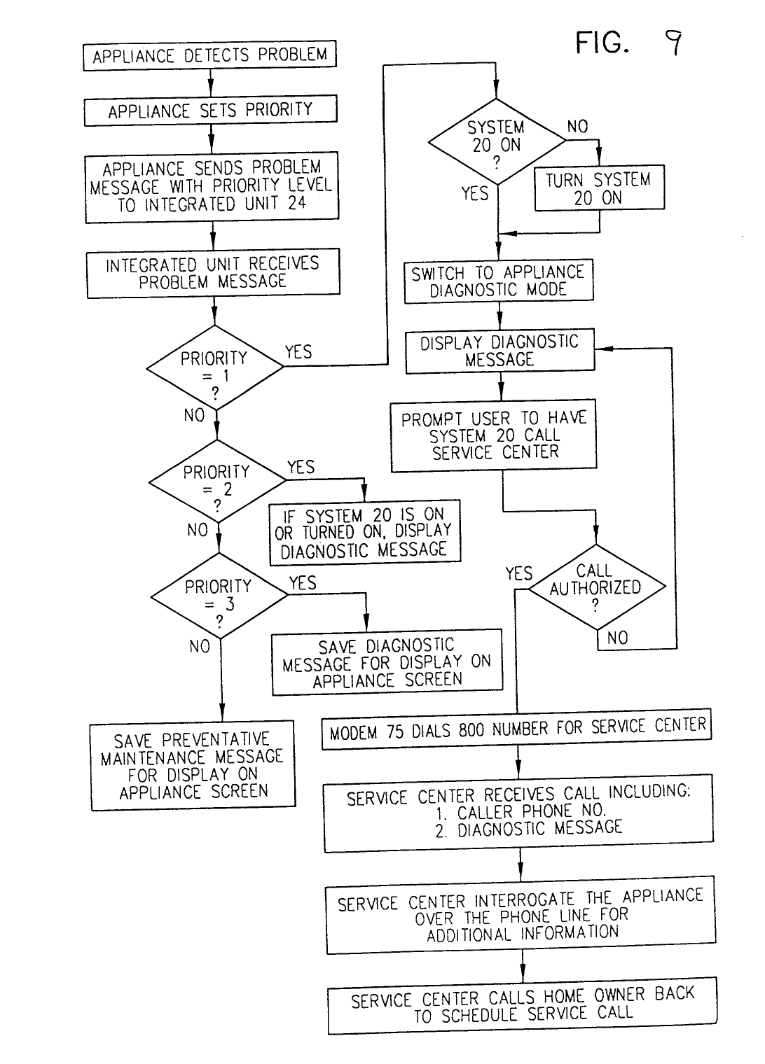

Display 132 and touch screen 130 may be employed to turn on each of the burners 134 . . . 140 and oven 142 of kitchen range 80 and to set the temperature of the selected heating element with the arrangement employed to turn on a burner being representative. In particular, included in display 132 under the label COOKING TOP are four icons 142 . . . 148 which correspond on a one-to-one basis with the stove top burners 134 . . . 140 of the range 24 shown in FIG. 3. The control icon 144 of right front burner 134 is typical and is shown in more detail in FIGS. 7 and 8.

With burner 134 turned off, icon 144 appears as shown in FIG. 7. Burner 134 is turned on by pressing touch screen 130 in the area over icon 144. This causes the icon to appear as shown in FIG. 8 with up and down buttons 152 and 154 and temperature scale 156 being manifested. The cook or other user of system 20 adjusts the temperature setting of burner 134 by pressing touch screen UP button 152 to raise the temperature setting or touch screen DOWN button 154 to lower the temperature setting. A colored bar 158 superimposed on temperature scale 156 visually informs the user of the temperature at which burner 134 is set.

If it is oven 142 which has instead been turned on in a manner akin to that just discussed, the information shown in display 132 under the labels OVEN CONTROL and OVEN appears. Manifested to the user of system 20 is the temperature for which oven 142 is set as well as legends identifying the burner elements which have been turned on.

Burner and oven temperature sensors collectively identified by reference character 162 in FIG. 4 transmit temperature readings to a microprocessor controller 164 in the control box 80 of kitchen range 26 over data bus 166.

Microprocessor 164 also controls the operation of burners 134 . . .140 and oven 142 in conformity with the temperatures and/or times selected by the equipment user.

Specifically, the user selects a heating element (burner or oven) to be used, the desired operating temperature, and, optionally, the time for which the selected heat element is to remain on and a starting or stopping time, using the touch screen controls described above. This manipulation of the user controls generates information which is transmitted to control box 80 by bus 166. The microprocessor then generates signals which are transmitted to appropriate ones of the power control switches collectively identified by reference characters 168 in FIG. 4 to operate the selected heating element at the temperature selected by the appliance user and, if a time operating cycle is selected, for the time and perhaps starting and stopping time selected by the user. Feedback utilized to keep an active heating element at a user selected temperature setting is provided by the associated sensor(s) in sensor complement 162.

Microprocessor 164 also transmits to the power line modem 82 in control box 80 information on the status of kitchen range 24, particularly information concerning the nature and seriousness of a problem with the appliance—for example, a defective or burned-out heating element.

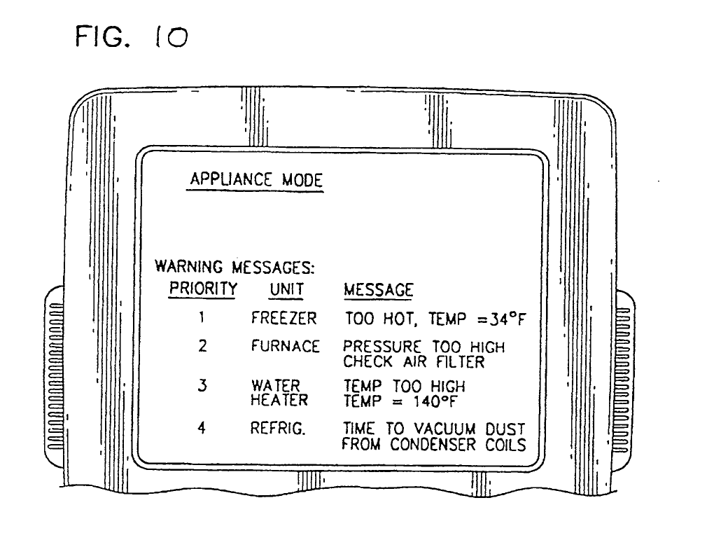

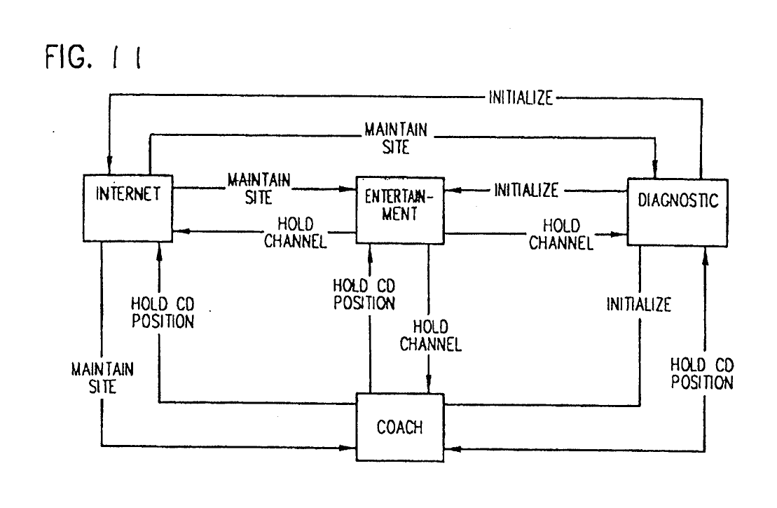

Referring still to the drawing, FIG. 9 is a logic flow diagram for the DIAGNOSTIC mode of operation of system 20. If the control unit of an appliance being monitored by system 20 detects a problem or determines that scheduled or unscheduled preventive maintenance should be performed, it sets a priority—typically 1 through 4—with priority 1 being the most serious and requiring immediate attention and priorities 2 through 4 being successively less serious. A message identifying the problem and its priority are sent to operating system 56 of integrated unit 26 along with an identification of the appliance affected. This information is displayed on screen 32 of integrated unit 24 as shown in FIG. 10. Representative messages and their priorities are identified in FIG. 10 by reference characters 170, 172, and 174.

If a priority 1 message is received and the CRT 31 of integrated unit 26 is off, the incoming priority 1 message causes PC board 58 to turn that system component on and switch to the DIAGNOSTIC mode of system 20 so that the message can be displayed. At the same time, the system user is prompted—typically by a static or blinking message on screen 32—to contact service/repair center 77. This prompt is repeated until the system user employs phone modem 75 to dial the service number for the service/repair center. Once a connection is established, integrated unit 24 transmits to the service/repair center the diagnostic message and the user's telephone number.

While the connection is established, the service/repair center personnel can also interrogate system 20 and obtain additional information pertinent to the problem. Thereafter, the system user is called to schedule a service call.

As discussed briefly above, this novel procedure for identifying the problem at the service center is very advantageous because it allows service/repair center personnel to select the correct parts, tools, etc. needed to correct the problem with the affected appliance, thereby making an additional trip to determine this information unnecessary.

If the problem is less serious—priority 2, 3, and 4—the message is displayed on CRT screen 32 if system 20 is turned on. Otherwise, the message is saved and displayed the next time that the CRT is turned on with the system automatically switching from the default ENTERTAINMENT mode to the DIAGNOSTIC mode to display the appropriate message.

Representative priority 1-4 messages for also representative appliances are shown in FIG. 10.

With system 20 up and running, the system user can check on the status of an appliance limited integrated unit 26 at any time by pressing the DIAGNOSTIC mode button 170 on remote control 28. Typically this will be done to ascertain when the next service call or other action respecting a supervised appliance is due.

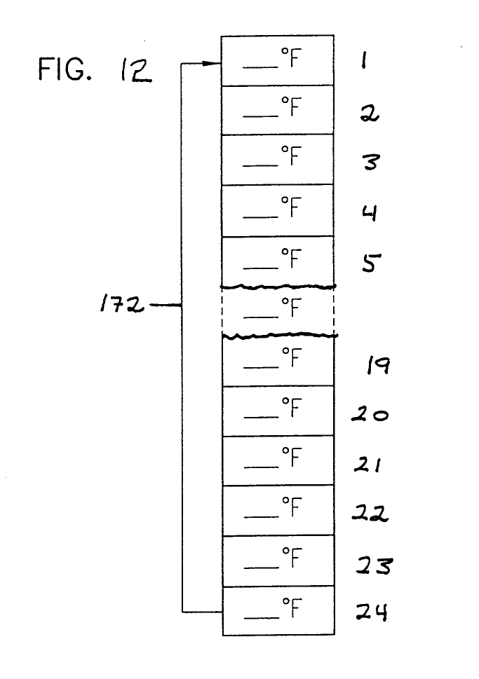

One of the important features of systems embodying the principles of the present invention is that operation of system 20 in a selected mode is “frozen” if operation of the system is switched from a currently selected mode to a different mode with operation in the switched from mode being resumed from the point at which it was frozen when the system user returns to that mode. This novel and important function of the present invention is shown diagrammatically in FIG. 11.

In the CD mode of operation of systems embodying the principles of the present invention, the system user can reach information on a task or subject of interest by navigating through a hierarchical set of menus as discussed in detail in U.S. application Ser. No. 08/621,638 cited above. If operation of the system is switched by the user from the CD mode to the INTERNET or ENTERTAINMENT modes, or if the system is switched automatically to the DIAGNOSTIC mode by operating system 56, the next time the CD mode is selected, the system user will be returned to the point at which the user had been navigating in the CD mode, even if the user moved to one or more intervening operating modes in the interim. This may be the point where the user was in the navigation process or the point at which a display of information was interrupted. This is important in that it relieves the user of the burden of navigating to the point of concern if the user exits from and then returns to the CD mode.

Similarly, if one exits the INTERNET operation, the INTERNET mode is “frozen” at the site logged onto upon exiting the INTERNET mode; and the user is returned to the selected channel the next time operation of the system in the ENTERTAINMENT mode is selected.

In the case of the ENTERTAINMENT mode, the channel selection is “frozen” when the system user exits this mode, and the user will be returned to the selected channel the next time operation of the system in the ENTERTAINMENT mode is selected.

Referring now to FIG. 12, it will be remembered that integrated unit 24 may be employed to supervise essentially any major appliance, not just a kitchen range. A significant example of such an appliance is a refrigerator.

The refrigerator temperature will be affected if a refrigerator problem arises. Consequently, and as suggested by FIG. 12, the temperature of the refrigerator being supervised is monitored at selected intervals—typically five minutes. The temperatures—1 through 24 in FIG. 12—are stored in memory on integrated unit CPU board 58 in a FIFO (first in first out) file with the oldest entry being replaced with the newest as suggested by arrow 172 after the file has been filled. The file will typically be set up to hold data collected over a 24-hour period.

The temperature data is transmitted as it is collected via power line 84 and power line modem 82 to the CPU board 58 of integrated unit 22 where the data for the latest 24-hour period is stored. Also stored in memory on CPU board 58 are temperature reference data sets. Each of these sets contains a pattern of temperatures which identify a particular problem—e.g. a belt coming loose or a loss of refrigerant. If the refrigerator fails, the data for the latest 24-hour period is compared with the reference data sets. If a match is found, the problem is identified. This is a significant advantage of the present invention, as it allows the service/repair personnel to identify the parts, tools, etc. they need to bring to the site of the failed refrigerator to repair that appliance. This eliminates the expense of two visits to the site, one to identify the problem and the second to effect the necessary repairs.

The invention may be embodied in many forms without departing from the spirit or essential characteristics of the invention. The present embodiments are therefore to be considered in all respects as illustrative and not restrictive. The scope of the invention is indicated by the appended claims, rather than by the foregoing description, and all changes which come within the meaning and range of equivalency of the claims are therefore intended to be embraced therein.

What is claimed is:

1. The combination of:
an appliance;
means for monitoring the performance of said appliance; and
means for transmitting data indicative of the status of said appliance from said monitoring means to a facility physically removed from the appliance and the appliance monitoring means.

2. A combination as defined in claim 1 in which the means for monitoring said appliance comprises:
a data processing and storage means; and
means for transmitting data from said appliance to said data processing and storage means.

3. A combination as defined in claim 2 in which the means for transmitting data from said appliance to said data processing and storage means comprises a modem and means connecting said modem to a power line servicing said appliance.

4. A combination as defined in claim 1 in which the means for transmitting ok information from said data processing and storage means to said facility comprises a phone modem.

5. A combination as defined in claim 1 in which the means for monitoring the appliance comprises an integrated unit with multiple user-selectable modes of operation.

6. A combination as defined in claim 5 in which one of said user-selectable modes is a DIAGNOSTIC mode, said integrated unit having the capability with said unit operating in the DIAGNOSTIC mode of displaying a message reporting the status of said appliance.

7. A combination as defined in claim 5 in which:
said integrated unit comprises a module comprising a player for a disc with
laser readable data stored thereon;
said integrated unit being operative in one of said multiple modes of operation to read data from said disc and communicate the retrieved data to a person using said integrated unit.

8. A combination as defined in claim 5 in which said integrated unit has a screen and an INTERNET mode of operation in which a user-actuatable means is available to establish a connection to the Internet, said integrated unit having means thereafter displaying information obtained from an Internet site on said screen.

9. A combination as defined in claim 5:
in which said integrated unit comprises a television with a screen;
said combination comprising a user-actuatable means for selecting operation of said system in a television viewing mode.

10. A combination as defined in claim 5 which comprises a remote control for selecting an operating mode of said integrated unit, said remote control having a separate, dedicated control for selecting each operating mode of said appliance.

11. A combination as defined in claim 5 in which said integrated unit is so constructed that, when operation of said unit is switched from one of said modes to a different mode, operation of said integrated unit in said one mode will resume at the point where operation of the integrated unit in said one mode was interrupted.

12. The combination of:
an appliance; and
an integrated unit for monitoring said appliance, said integrated unit comprising a screen;
said integrated unit having an operating system with the capability of powering up said integrated unit to display a message on said screen if a fault arises in said appliance.

13. A system which comprises:
means for monitoring the performance of an appliance; and
means operable if a fault in the operation of said system occurs for communicating the existence and nature of said fault to a service or repair facility remote from said appliance.

14. The combination of:
an appliance; and
an integrated unit for monitoring said appliance;
said integrated unit having a screen and an operating system capable of causing a display message indicative of a fault in said appliance being displayed on said screen when said integrated unit is powered up.

15. The combination of:
an appliance; and
a unit for monitoring the performance of the said appliance;
said appliance comprising a sensor for monitoring a parameter indicative of the performance of the said appliance; and
said combination for the comprising:
means for sampling the data available from said sensor at periodic intervals means for transmitting said data to said monitoring unit;
means for storing said data in memory in said monitoring unit; and
means for comparing the stored data with reference data and thus identifying the nature of the problem if said appliance fails.

16. A combination as defined in claim 15 in which said data is stored in a FIFO file, the oldest data being replaced with the newest data after the file is filled.

17. A system which comprises:
a supervisory unit; and
means for transmitting to said supervisory unit information on an appliance
associated with said unit;
said supervisory unit comprising a screen and an operating system for displaying on said screen a message reflecting the status of said appliance.

18. A system as defined in claim 17 in which:
said supervisory unit comprises an electrically powered display device in which said screen is incorporated and means for turning said display device on and off; and
the operating system of said supervisory has the capability of turning said display device on and displaying said message if the message is received when said display device is turned off.

19. A system as defined in claim 17 in which:
the operating system of said supervisory unit comprises an electrically operated display device in which said screen is incorporated; and
the operating system of said supervisory unit has the capability of displaying said messages only: (a) if said message display device is turned on when the message is received, or (b) when said display device is subsequently turned on if said message is received when the display device is turned off.
